(19) United States
(12) Patent Application Publication
(10) Pub. No.: US 2008/0024950 A1
(43) Pub. Date: Jan. 31, 2008

(54) SITE-ADAPTIVE AC CURRENT LIMITING FOR RECTIFIERS AND DC POWER PLANTS

(75) Inventors: Anurag Jagota, Plano, TX (US); Roy J. Davis, Rowlett, TX (US)

Correspondence Address: HITT GAINES P.C., P.O. BOX 832570, RICHARDSON, TX, 75083, US

(73) Assignee: Tyco Electronics Power Systems, Inc. A Nevada Corporation, Mesquite, TX (US)

(21) Appl. No.: 11/460,027

(22) Filed: Jul. 26, 2006

(51) Int. Cl. H01H 73/00

(52) U.S. Cl. 361/115

(57) ABSTRACT

The present invention provides a site-adaptive current manager for use with a rectifier. In one embodiment, the site-adaptive current manager includes a current limit programmer configured to set an AC input current limit for the rectifier corresponding to a site-restricted current capability. The site-adaptive current manager also includes an input current sensor coupled to the current limit programmer and configured to determine an AC input current of the rectifier. The site-adaptive current manager further includes a rectifier current coordinator coupled to the current limit programmer and configured to restrict the AC input current based on the AC input current limit.

### TECHNICAL FIELD OF THE INVENTION

The present invention is directed, in general, to power conversion and, more specifically, to a site-adaptive current manager, a method of managing a site-adaptive current and a DC power plant employing the manager or the method.

### BACKGROUND OF THE INVENTION

A DC power plant usually employs a plurality of rectifiers that convert standard AC input power to a DC output current at a specified DC output voltage. The design and construction of new DC power plants allows for proper tailoring and coordination between AC input protection devices, such as circuit breakers, and rectifier DC output current capabilities. Even then, unexpected changes in load requirements during construction can cause problems.

Retrofitting existing DC power plants with new rectifiers may increase problems several fold. For these cases, much of the existing AC input cabling and AC input protection devices are often retained while many of the rectifiers may be upgraded. Maintenance service and cost considerations dictate that inventories of spare replacement rectifiers be kept as small as possible. However, many different rectifier current ratings such as 10 A, 20 A, 30 A (even ranging up to 125 A, or so) may need to be employed in the DC power plant due to existing AC input cabling and AC input protection devices. This is particularly unfortunate if a large percentage of the rectifier current ratings deployed could be accommodated by only two current ratings (e.g., 20 A and 50 A).

Rectifiers draw AC input current based on their output power, operating environment and input line conditions. Though the intended input current may be well known and documented during site engineering and planning, actual site conditions may turn out not to be safe or adequate to conduct the full rated current input of a rectifier. For example, the feature-set of a system may allow for 25 A building blocks, but the existing AC supply can only accommodate 20 A building blocks. Another issue is lack of certainty about what is actually available. For example, it may be assumed that a 25 A breaker will be available, but it works out during installation that it is not. These issues delay installation since at least a portion of product selection may have to be redone based on existing site conditions.

Accordingly, what is needed in the art is an enhanced way to provide modular rectifier capability that is scalable to meet in-situ site conditions.

### SUMMARY OF THE INVENTION

To address the above-discussed deficiencies of the prior art, the present invention provides a site-adaptive current manager for use with a rectifier. In one embodiment, the site-adaptive current manager includes a current limit programmer configured to set an AC input current limit for the rectifier corresponding to a site-restricted current capability. The site-adaptive current manager also includes an input current sensor coupled to the current limit programmer and configured to determine an AC input current of the rectifier. The site-adaptive current manager further includes a rectifier current coordinator coupled to the input current sensor and configured to restrict the AC input current based on the AC input current limit.

In another aspect, the present invention provides a method of managing a site-adaptive current for use with a rectifier. The method includes setting an AC input current limit for the rectifier corresponding to a site-restricted current capability and determining an AC input current of the rectifier. The method also includes restricting the AC input current based on the AC input current limit.

The present invention also provides, in yet another aspect, a DC power plant. The DC power plant includes an AC current supply having a site-restricted current capability, at least one DC rectifier coupled to the AC current supply and a controller coupled to the at least one DC rectifier. The DC power plant also includes a site-adaptive current manager coupled to the controller. The site-adaptive current manager has a current limit programmer that sets an AC input current limit for the rectifier corresponding to the site-restricted current capability. The site-adaptive current manager also has an input current sensor, coupled to the current limit programmer, that determines an AC input current of the rectifier and a rectifier current coordinator, coupled to the input current sensor, that restricts the AC input current based on the AC input current limit.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a systems diagram of a DC power plant, constructed in accordance with the principles of the present invention;

FIG. 2 illustrates a flow diagram of an embodiment of a method of individually managing a site-adaptive current, carried out in accordance with the principled of the present invention; and

FIG. 3 illustrates a flow diagram of an embodiment of a method of managing a collection of site-adaptive currents, carried out in accordance with the principles of the present invention.

### DETAILED DESCRIPTION

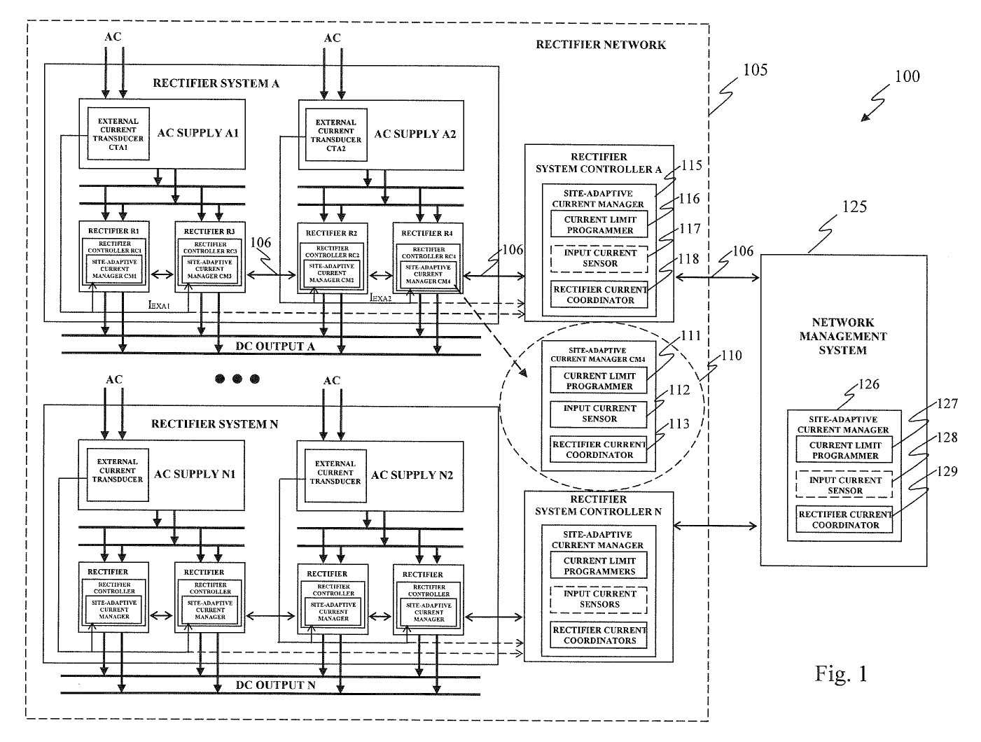

Referring initially to FIG. 1, illustrated is a systems diagram of a DC power plant, generally designated 100, constructed in accordance with the principles of the present invention. In the illustrated embodiment, the DC power plant 100 includes a rectifier network 105 having a plurality of rectifier systems A-N wherein each of the plurality of rectifier systems A-N employs two banks of rectifiers. Each of the two banks of rectifiers consists of two rectifiers designated as odd or even rectifiers, as shown. The rectifier network 105 also includes rectifier system controllers A-N corresponding to the rectifier systems A-N, respectively. The DC power plant 100 also includes a network management system 125. The rectifier system A, which may be considered typical of the remaining rectifier systems, will be described in more detail.

The rectifier system A includes odd and even AC supplies A1, A2 that have site-restricted current capability inputs connected to separate AC sources employing separate input protection devices (i.e., AC input current breakers). The odd and even AC supplies or distribution systems A1, A2 provide AC outputs that are respectively connected to odd and even rectifiers R1, R3 and R2, R4, as shown. Outputs from the odd and even rectifiers R1, R3 and R2, R4 combine to provide a DC output A for the rectifier system A. Each of the odd and even AC supplies A1, A2 include odd and even external current transducers CTA1, CTA2 that respectively measure the AC input currents I_{EXA1}, I_{EXA2} flowing into the odd and even AC supplies A1, A2. The odd and even rectifiers R1, R3 and R2, R4 include odd and even rectifier controllers RC1, RC3 and RC2, RC4, respectively. Correspondingly, the odd and even rectifier controllers RC1, RC3 and RC2, RC4 respectively include odd and even self-adaptive current managers CM1, CM3 and CM2, CM4, as shown.

The DC power plant 100 illustrates several embodiments of a current manager that is site-adaptive. Each of these embodiments provides AC input current limiting that allows for safe operation of the DC rectifier systems employed in the DC power plant 100 by making them adaptive to prevailing site AC input current conditions, regardless of their rated output current capability.

In one embodiment, an individual self-adaptive current manager is dedicated to a single rectifier and employs a dedicated, internal rectifier input current sensor. In another embodiment, this dedicated, individual self-adaptive current manager employs an external current transducer that measures an AC input current shared with other rectifiers being fed by the same AC supply. In yet another embodiment, a system self-adaptive current manager is employed in a rectifier system controller that oversees a rectifier system having a plurality of AC supplies and rectifiers. In still another embodiment, a network self-adaptive current manager is employed in a network management system that oversees a rectifier network employing a plurality of rectifier systems or individual rectifiers.

Use of these embodiments of self-adaptive current managers may be seen to provide a hierarchy of AC input current management solutions that include applications ranging from a single rectifier up to and including a rectifier network involving a plurality of rectifier systems and their associated rectifiers. Of course, a combination of these solutions may also be applied, as dictated by a particular site associated with the DC power plant 100.

Operationally, for example, suppose the even rectifier R4 has been sized for a 25 A AC input current based on employing 2500W rectifiers, and the actual site of the DC power plant 100 permits an AC input current of only 20 A (corresponding to a site-restricted current capability) for this rectifier. The individual site-adaptive current manager CM4 will dynamically adjust the DC output current limit of the even rectifier R4 to lower levels by reducing its power output as its AC input current attempts to rise above 20 A.

An embodiment of the individual site-adaptive current manager CM4 may be seen in an enlarged view 110. The individual site-adaptive current manager CM4 is coupled to the rectifier controller RC4 and includes a current limit programmer 111, an input current sensor 112 and a rectifier current coordinator 113. The current limit programmer 111 sets an AC input current limit for the rectifier R4 corresponding to a site-restricted current capability associated with the AC supply A2. The input current sensor 112 is coupled to the current limit programmer 111 and determines an AC input current of the rectifier R4. The rectifier current coordinator 113 is coupled to the input current sensor 112 and restricts the AC input current based on the AC input current limit.

The current limit programmer 111 sets an AC input current limit for the even rectifier R4 that is less than the site-restricted current capability of 20 A associated with the AC supply A2. The input current sensor 112 measures the actual AC input current flowing into the even rectifier R4 by employing an internal current transducer dedicated to the even rectifier R4. In an alternative embodiment, the input current sensor 112 is configured to employ the external current transducer CTA2 and its corresponding output current I_{EXA2}.

The rectifier current coordinator 113 ensures that the actual AC input current is restricted below the AC input current limit by causing the even rectifier R4 to “clamp down” thereby limiting its output DC current. Then, the rectifier current coordinator 113 may further limit the output DC current by incrementally decreasing it, as appropriate to a particular operating situation. Keeping the AC input current below the AC input current limit ensures that the rectifiers do not operate input protection devices due to transient overload conditions. Actively maintaining the AC input current also ensures that input cable temperatures remain within design limits, especially during “brown-out” conditions, which tend to generate greater AC input currents.

A system site-adaptive current manager 115 is coupled to the rectifier system controller A and provides AC input current management for the rectifier system A. A serial control link 106 is employed to communicate with the odd and even rectifier controllers RC1-RC4. Typically, the individual site-adaptive current managers CM1-CM4 are not employed in this configuration. However, configurations mixing the use of individual and system site-adaptive current managers are well within the scope of the present invention.

The system site-adaptive current manager 115 includes a current limit programmer 116, an input current sensor 117 and a rectifier current coordinator 118 that operate on the system level. That is, they perform the same basic functions as the individual current manager units, but accommodate each rectifier in the system employing the serial control link 106. The current limit programmer 116 sets AC current limits for each of the rectifiers R1-R4 associated with the rectifier system A. The input current sensor 117 employs the external current transducers CTA1, CTA2 to measure the actual AC input currents flowing into these rectifiers. These currents may be conveyed via the serial control link 106 directly from each rectifier or from the transducers, as indicated in FIG. 1.

The rectifier current coordinator 118 restricts the AC input currents of each rectifier, through communication with the individual rectifier controllers, by controlling each of the DC output currents based on the AC input current limit set for each, as was discussed with respect to the individual rectifier current coordinators, above. Additionally, the rectifier current coordinator 118 may incrementally increase an output DC current limit (i.e., clamp-down value) of the rectifier while maintaining the AC input current less than the AC input current limit, thereby allowing improved effectiveness for the rectifier.

A network site-adaptive current manager 126 is coupled to the network management system 125, which is in turn coupled to the rectifier system controller A via the serial control link 106. The network site-adaptive current manager 126 is further coupled to all remaining rectifier system controllers via their corresponding serial control links, as shown in FIG. 1. The network site-adaptive current manager 126 includes a current limit programmer 127, an input current sensor 128 and a rectifier current coordinator 129 that analogously operate on the network level to limit and control AC input currents for the entire rectifier network 105.

Any of the site-adaptive current managers discussed above may also be employed to provide alarms if a current measurement cannot be adjusted from the programmed value. Additionally, the site-adaptive current managers provide knowledge of which AC infrastructures can handle more that others thereby allowing adjustments in some rectifier loads to accommodate required conditions.

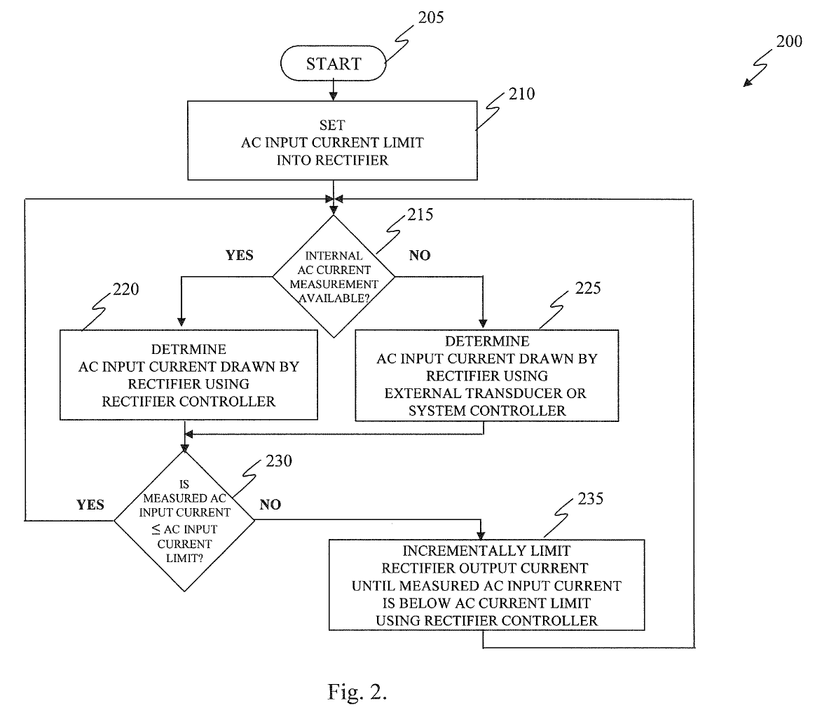

Turning now to FIG. 2, illustrated is a flow diagram of an embodiment of a method of individually managing a site-adaptive current, generally designated 200, carried out in accordance with the principles of the present invention. The method 200 is for use with an individual rectifier and starts in a step 205. Then, in a step 210, an AC input current limit is set for the rectifier corresponding to a site-restricted current capability, which is provided by an AC input current breaker. In a first decisional step 215, it is determined if there is an AC input current measurement available internally to the rectifier.

If the rectifier employs an internal AC input current measurement, then the AC input current drawn by the rectifier is determined using an individual rectifier controller associated with the rectifier, in a step 220. If the rectifier does not employ an internal AC input current measurement, the AC input current is determined using an external current transducer or a system controller associated with the rectifier, in a step 225.

In a second decisional step 230, it is determined if the measured AC input current is less than or equal to the AC input current limit set in the step 210. If the measured AC input current is less than or equal to the AC input current limit, the method 200 returns to the first decisional step 210. If the measured AC input current is greater than the AC input current limit, The rectifier output current is incrementally restricted or limited (i.e., reduced) until the measured AC input current is below the AC input current limit in a step 235. Then, the method 200 returns to the first decisional step 215.

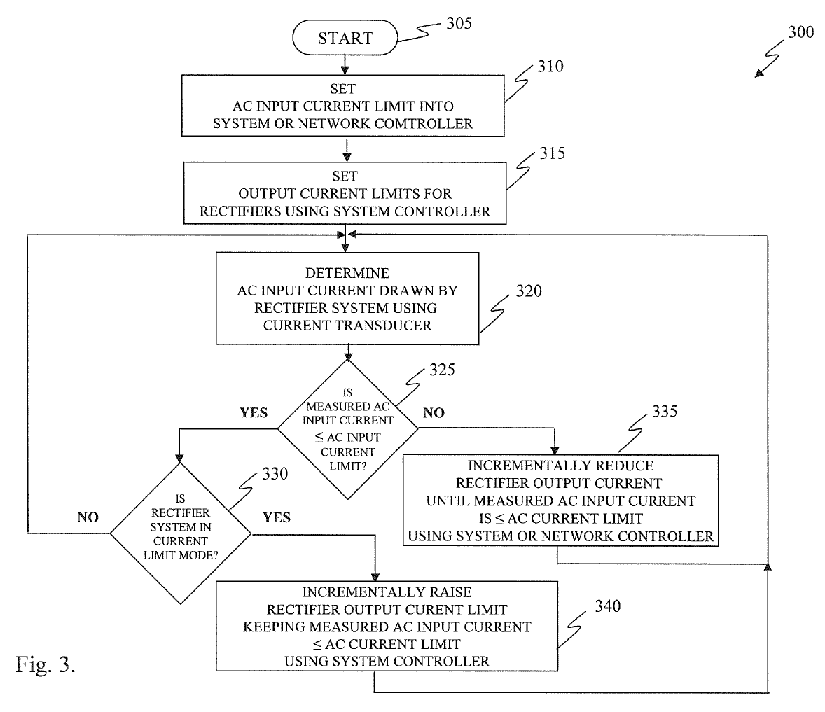

Turning now to FIG. 3, illustrated is a flow diagram of an embodiment of a method of managing a collection of site-adaptive currents, generally designated 300, carried out in accordance with the principles of the present invention. The method 300 is for use with a rectifier system or a network of rectifiers and starts in a step 305. Then, in a step 310, an AC input current limit is set into a system or network management controller for each individual rectifier employed in the system or network. In a step 315, output current limits for all rectifiers employed are set using the system or network management controllers.

AC input currents that are drawn by the rectifier systems or the rectifier network, using system or network current transducers, are determined in a step 320. In a first decisional step 325, it is determined if all of the measured AC input currents are less than or equal to their respective AC input current limits. If all of the measured AC input currents are less than or equal to their respective AC input current limits, a second decisional step 330 determines if there is a rectifier or a rectifier system that is in an output current limit mode. If no rectifier or rectifier system is in an output current limit mode, the method 300 returns to the step 320. If a rectifier or rectifier system is in an output current limit mode, the output current limit mode is incrementally raised under the constraint of keeping the measured AC input current less than or equal to the AC input current limit, in a step 340. The method 300 then returns to the step 320.

If the first decisional step 325 determines that the measured AC input current is not less than or equal to the AC input current limit for a rectifier or rectifier system, The rectifier or rectifier system output current is incrementally reduced. This continues until the measured AC input current is less than or equal to the AC input current limit using the system or network controller, in a step 335. Then, the method 300 returns to the step 320.

While the methods disclosed herein have been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps is not a limitation of the present invention.

In summary, embodiments of the present invention employing a site-adaptive current manager, a method of managing individual or collections of site-adaptive currents and a DC power plant employing the manager or the methods have been presented. Advantages include the ability to employ and manage rectifiers that have AC input current capabilities greater than their AC input current supply, due to a site-restricted current capability (e.g., an AC input current breaker). This capability allows operation of the rectifiers within the site without tripping their input protection devices. This capability also allows a reduction in the number of different capacity rectifiers needed to populate a DC power plant thereby reducing both spares inventory and costs associated with the rectifiers.

Although the present invention has been described in detail, those skilled in the art should understand that they can make various changes, substitutions and alterations herein without departing from the spirit and scope of the invention in its broadest form.

What is claimed is:

1. A site-adaptive current manager for use with a rectifier; comprising:
a current limit programmer configured to set an AC input current limit for said rectifier corresponding to a site-restricted current capability;
an input current sensor coupled to said current limit programmer and configured to determine an AC input current of said rectifier; and
a rectifier current coordinator coupled to said input current sensor and configured to restrict said AC input current based on said AC input current limit.

2. The manager as recited in claim 1 wherein restricting said AC input current employs limiting an output DC current of said rectifier.

3. The manager as recited in claim 2 wherein limiting said output DC current employs incrementally decreasing said output DC current.

4. The manager as recited in claim 1 wherein restricting said AC input current employs one selected from the group consisting of:
an individual rectifier controller;
a rectifier system controller; and
a network management system.

5. The manager as recited in claim 1 wherein determination of said AC input current is provided by a current transducer that is either internal or external to said rectifier.

6. The manager as recited in claim 1 wherein said site-restricted current capability is provided by an AC input current protection device.

7. The manager as recited in claim 1 further comprising incrementally increasing an output DC current limit of said rectifier when said AC input current is less than said AC input current limit.

8. A method of managing a site-adaptive current for use with a rectifier; comprising:
setting an AC input current limit for said rectifier corresponding to a site-restricted current capability;
determining an AC input current of said rectifier; and
restricting said AC input current based on said AC input current limit

9. The method as recited in claim 8 wherein restricting said AC input current employs limiting an output DC current of said rectifier.

10. The method as recited in claim 9 wherein limiting said output DC current employs incrementally decreasing said output DC current.

11. The method as recited in claim 8 wherein restricting said AC input current employs one selected from the group consisting of:
an individual rectifier controller;
a rectifier system controller; and
a network management system.

12. The method as recited in claim 8 wherein determination of said AC input current is provided by a current transducer that is either internal or external to said rectifier.

13. The method as recited in claim 8 wherein said site-restricted current capability is provided by an AC input current protection device.

14. The method as recited in claim 8 further comprising incrementally increasing an output DC current limit of said rectifier when said AC input current is less than said AC input current limit.

15. A DC power plant, comprising:
an AC current supply having a site-restricted current capability;
at least one DC rectifier coupled to said AC current supply;
a controller coupled to said at least one DC rectifier; and
a site-adaptive current manager coupled to said controller, including:
a current limit programmer that sets an AC input current limit for said rectifier corresponding to said site-restricted current capability,
an input current sensor, coupled to said current limit programmer, that determines an AC input current of said rectifier, and
a rectifier current coordinator, coupled to said input current sensor, that restricts said AC input current based on said AC input current limit

16. The DC power plant as recited in claim 15 wherein restricting said AC input current employs limiting an output DC current of said rectifier.

17. The DC power plant as recited in claim 16 wherein limiting said output DC current employs incrementally decreasing said output DC current.

18. The DC power plant as recited in claim 15 wherein restricting said AC input current employs one selected from the group consisting of:
an individual rectifier controller;
a rectifier system controller; and
a network management system.

19. The DC power plant as recited in claim 15 wherein determination of said AC input current is provided by a current transducer that is either internal or external to said rectifier.

20. The DC power plant as recited in claim 15 wherein said site-restricted current capability is provided by an AC input current protection device.

21. The DC power plant as recited in claim 15 further comprising incrementally increasing an output DC current limit of said rectifier when said AC input current is less than said AC input current limit.
